(19) United States
(12) Patent Application Publication
(10) Pub. No.: US 2003/0200102 A1
(43) Pub. Date: Oct. 23, 2003

(54) Real estate transaction method

(76) Inventor: Kamose Tao, Baltimore, MD (US)

Correspondence Address: LARRY J. GUFFEY, WORLD TRADE CENER - SUITE 1800, 401 EAST PRATT STREET, BALTIMORE, MD, 21202, US

(21) Appl. No.: 10/125,278

(22) Filed: Apr. 17, 2002

(51) Int. Cl. G06F 17/60

(52) U.S. Cl. 705/1

(57) ABSTRACT

The present invention discloses a method for transferring residential property that is in need of repair and located in an economically disadvantaged neighborhood. The method involves a seller, a buyer, a nonprofit entity and a building contractor, with the method comprising the steps of: (1) the seller contracting to sell the property to the buyer contingent upon a specified amount of the sales price being donated to the nonprofit, (2) the nonprofit agreeing to accept the seller's donation and provide the seller with a receipt that can be used by the seller for tax purposes, and to use at least a specified amount of the donation to pay the contractor for specified repairs and renovations to the property, (3) the contractor agreeing to perform the specified repairs and renovations on the property for the specified amount of seller's donation, and (4) the buyer agreeing to buy the property from the seller under the condition that the specified repairs and renovations are to be made to the property by the building contractor.

### BACKGROUND OF THE INVENTION

1. Field of the Invention

The present invention relates to business practices and management. More particularly, this invention relates to a new method for transferring dilapidated, residential property in an economically disadvantaged neighborhood.

2. Description of the Related Art

One of the United States' major urban problems is the state of conditions that exist within the economically disadvantaged neighborhoods of its cities. These neighborhoods usually have an abundance of decaying, older residential properties that are owned by absentee landlords and rented to low-income individuals. There are often many vacant properties in such neighborhoods, and there is usually little in the way of quality housing for rental or owner occupancy.

Rehabilitating such neighborhoods is truly a daunting task. Potential investors have little incentive to make the investments necessary to rehabilitate such neighborhoods. Absentee, residential property owners in such neighborhoods are often trapped in their investments in such properties. Real estate transactions in such neighborhoods are often very difficult to complete.

Lending institutions that serve such neighborhoods often adopt stringent lending policies which make it more difficult for low and moderate income buyers and investors to buy and sell properties in these neighborhoods. An example of such a policy is “seasoning,” where institutions will not lend on a property unless it owner has owned it for at least six to twelve months. Thus, if the owner were to use his money to quickly rehabilitate the property, the owner could not get any of his money out of the property until the end of required “seasoning” period.

Various non-profit, community development groups will often serve such neighborhoods. These groups will sometimes try to facilitate residential, real estate transaction in such neighborhoods as a means of fostering rehabilitation in the neighborhood. These transactions will often involve the absentee owner donating the residential property to the non-profit, community development group, who then uses its other sources of funding to rehabilitated the property and later sells the property to a qualified, low-income buyer. The community development group may even help the new homebuyer by providing a grant to the homebuyer which covers some or all of the homebuyer's down payment and closing costs. Additionally, the community development group may even provide the new homebuyer with counseling services on the topic of the responsibilities and requirements of home ownership, thereby seeking to prevent potential problems associated with the late payment of necessary mortgages and the inattention to necessary home maintenance matters.

Despite the best efforts of many such community, development groups, the current efforts to rehabilitate decaying, metropolitan neighborhoods appear to be having only minimal, beneficial impacts. Few residential, real estate transactions seem to be occurring that are directed at property rehabilitation. There exists a continuing need for new and improved methods for facilitating real estate transaction in such neighborhoods that are directed at property rehabilitation. The present invention is directed at this need.

### SUMMARY OF THE INVENTION

The present invention is generally directed to satisfying the needs set forth above and overcoming the limitations and problems identified with prior real estate transactions involving the transfer of residential property in economically disadvantaged neighborhoods.

In accordance with one preferred embodiment, the present invention takes the form of a method for transferring real property involving a seller, a buyer, a nonprofit entity and a contractor. This method comprises the steps of: (1) the seller contracting to sell the property, at a sales price approximately equivalent to its appraised value, to the buyer contingent upon a specified percentage of the sales price being donated to the nonprofit at the closing of the sale, (2) the nonprofit agreeing to: (2a) accept the seller's donation and provide the seller with a receipt that can be used by the seller for tax purposes, (2b) use a specified percentage of seller's donation to provide the buyer with a grant at the closing which reduces the cost of the buyer purchasing the property, and (2c) hold in escrow a specified percentage of the donation that is to be paid to the contractor upon satisfactory completion of specified repairs and renovations to the property, (3) the contractor agreeing to perform the specified repairs and renovations on the property for the specified percentage of seller's donation being held in escrow by the nonprofit until the satisfactory completion of the repairs, (4) the buyer agreeing to buy the property from the seller under the following conditions: (4a) the purchase price to be the approximate appraised value of the property, (4b) buyer to receive at closing a grant, from the nonprofit in the amount of a specified percentage of seller's donation, for the purposes of reducing the cost to the buyer of purchasing the property, and (4c) specified repairs and renovations to be made to the property by a contractor who is to be paid by the nonprofit from a specified percentage of the seller's donation that is to be held in escrow by the nonprofit until the satisfactory completion of the repairs and renovations; (5) wherein, if the buyer is an investor, the investor also will be provided by the nonprofit with: (5a) property management counseling, (5b) for a period of up to two years after the closing, property management services, and (5c) periodic inspection of the property to ensure its upkeep.

The present invention is seen to overcome the limitations of the prior art. It is therefore an object of the present invention to provide an improved method for transferring residential property in economically disadvantaged neighborhoods.

It is another object of the present invention to reduce the manpower effort and expenses associated with transferring residential property in economically disadvantaged neighborhoods.

It is a yet another object of the present invention to provide a real estate method that helps to foster the rehabilitation and stabilization of decaying urban neighborhoods. Part of this fostering of the rehabilitation and stabilization of decaying urban neighborhoods will include the education of prospective homeowners and investors regarding proper property maintenance, financial responsibilities to lenders, and how to enlist the aid of appropriate parties should problems arise in fulfilling contractual obligations related to the rehabbed properties.

It is still another object of the present invention to provide the means and an incentive for real estate developers to undertake projects with nonprofit, community development groups to rehabilitate residential property in economically disadvantaged neighborhoods.

It is a yet another object of the present invention to increase lending activity in these economically disadvantaged neighborhoods by introducing real estate transaction methods that produce a large class of buyers who timely pay their mortgages and properly maintain their rehabbed properties.

It is still another object of the present invention to demonstrate that the buyers of such rehabbed properties, who acquire them under the real estate transaction methods disclosed by the present invention, will exhibit lower foreclosure rates than the buyers of comparable properties who use standard real estate transaction methods.

It is a further object of the present invention to provide the means and an incentive for lenders to undertake projects, with nonprofit community development groups and real estate developers, to rehabilitate residential property in economically disadvantaged neighborhoods.

These and other objects and advantages of the present invention will become readily apparent as the invention is better understood by reference to the accompanying drawings and the detailed description that follows.

### BRIEF DESCRIPTION OF THE DRAWINGS

FIGS. 1(a) and 1(b) illustrate a typical Settlement Statement that might be created using the method of the present invention.

FIG. 2 provides an example of the type of document that a nonprofit community development group might use with the present invention to document a seller's donation.

FIG. 3 provides an example of the type of document that a nonprofit community development group might have a buyer sign to document the buyer's receipt of the entirety of the seller's donation to the community development group.

FIG. 4 illustrates the type of agreement that might be used under the present invention by a nonprofit community development group and buyer to document their agreements.

FIG. 5 illustrates a typical “management services” agreement between an investor-buyer and a nonprofit community development group using the method of the present invention.

### DESCRIPTION OF THE PREFERRED EMBODIMENT

For purposes of explanation and not limitation, specific details are set forth below in order to provide a thorough understanding of the present invention. However, it will be apparent to one skilled in the art that the present invention may be practiced in other embodiments that depart from these specific details. In other instances, detailed descriptions of well known are omitted so as not to obscure the description of the present invention with unnecessary detail.

Referring now to the drawings wherein are shown various aspects of preferred embodiments and wherein like reference numerals designate like elements throughout, there is shown in these drawings the various aspects of a method for transferring real property that needs rehab work. This method involves the traditional seller and buyer, and a nonprofit entity who will help to facilitate the transaction and a building contractor who will perform specified rehab work on the property being transferred.

This method comprises the steps of (1) the seller contracting to sell the property, at a sales price approximately equivalent to its appraised value after rehab, to the buyer contingent upon a specified amount of the sales price being donated to the nonprofit at the time of the closing of the sale, (2) the nonprofit agreeing to: (2a) accept the seller's donation and provide the seller with a receipt that can be used by the seller for tax purposes, (2b) use a specified amount of the seller's donation to provide the buyer with a grant at the closing which reduces the buyer's cost of purchasing the property, and (2c) hold in escrow the balance of the donation which is to be paid to the building contractor upon satisfactory completion of the specified rehab work on the property, (3) the building contractor agreeing to perform, before a specified date, the specified rehab work on the property for the specified, held-in-escrow amount of seller's donation, and (4) the buyer agreeing to buy the property from the seller under the following conditions: (4a) the purchase price to be the approximate appraised value of the property, (4b) buyer to receive at closing a grant, from the nonprofit and in the amount of a specified portion of seller's donation, for the purposes of reducing the cost to the buyer of purchasing the property, and (4c) specified rehab work to be made to the property before a specified date by a building contractor who is to be paid by the nonprofit from a specified amount of the seller's donation that is to be held in escrow by the nonprofit until the satisfactory completion of the rehab work.

If the buyer is an investor, the investor can also be provided by the nonprofit with other services that seek to aid the investor in realizing the expect return on this investment. The services may include: (a) property management counseling, (b) for a specified period after the closing, management of the property by a qualified, property management services, (c) periodic inspection of the property to ensure its upkeep, and (d) educational instruction on such matters as: (i) means for structuring the financial deal, and (ii) legal issues pertinent to the transaction, including overview of landlord-tenant law and local, state and federal regulations governing lead paint issues.

The method of the present invention is seen to greatly increase the chances that such residential, real estate transactions and subsequent rehab work will actually occur, Under the prior art methods of operation, a nonprofit community development group that was interested in such work usually had to sit and wait for the appropriate donation of residential property to occur. It then had to assess whether there would likely be a buyer for the property if it were to be rehabbed. All of this took great amounts of time and often involved the efforts of many people having only a very partial knowledge of the many aspects involved in bringing such a rehab project and eventual sale of the property to fruition.

Providing for the transfer of the property, along with a contract for its rehab, in a single transaction has the effect of creating a marketplace for such transactions. It allows many real estate developers and brokers who are knowledgeable in all the necessary aspects of such a transaction to work with all the appropriate parties (e.g., absentee landlords, nonprofit community development group, and potential rehabbed homebuyers and rental property investors, building contractors) to actually make such residential, rehab projects happen. Using the method of the present invention, real estate developers and brokers see how to and have an incentive to put such deals together. They are effectively empowered to go out and try to put such deals together.

Another advantage of the method of the present invention is that it creates better opportunities for lenders. Using the current real estate methods, lenders are often asked to lend money to builders or nonprofits for work on rehab projects that then must be sold into highly speculative markets. This lending scheme can be contrasted with that created by the present invention where the lender is asked to lend to a specific, qualified buyer for a to-be-rehabbed property on which the loan to appraised value of the property will be in the range of 75% to 85%.

Lenders also benefit from the reduced foreclosure rates that are expected to be experienced using the real estate transaction methods of the present invention. Initial foreclosure rates experienced in prototype transactions in selected economically disadvantages neighborhoods with the current invention have been zero. This is to be compared to current foreclosure rates, in such neighborhoods and using standard real estate transaction methods, of 75% to 85%.

The present invention provides a win-win situation for all those utilizing the methods disclosed herein: investors ultimately receive a better return on their investment, community development groups have more success at improving the housing conditions in the areas they serve, and local governments contribute to the rehabilitation of their neighborhoods and better living conditions for their citizens.

Since the method of the present invention allows for the participation of investors that wish to rehab the subject properties and use them as rental properties, this method effectively promotes more contact being investors and the nonprofit, community development groups. These groups have historically limited their involvement in neighborhood rehabilitation projects to dealing only with prospective homebuyers.

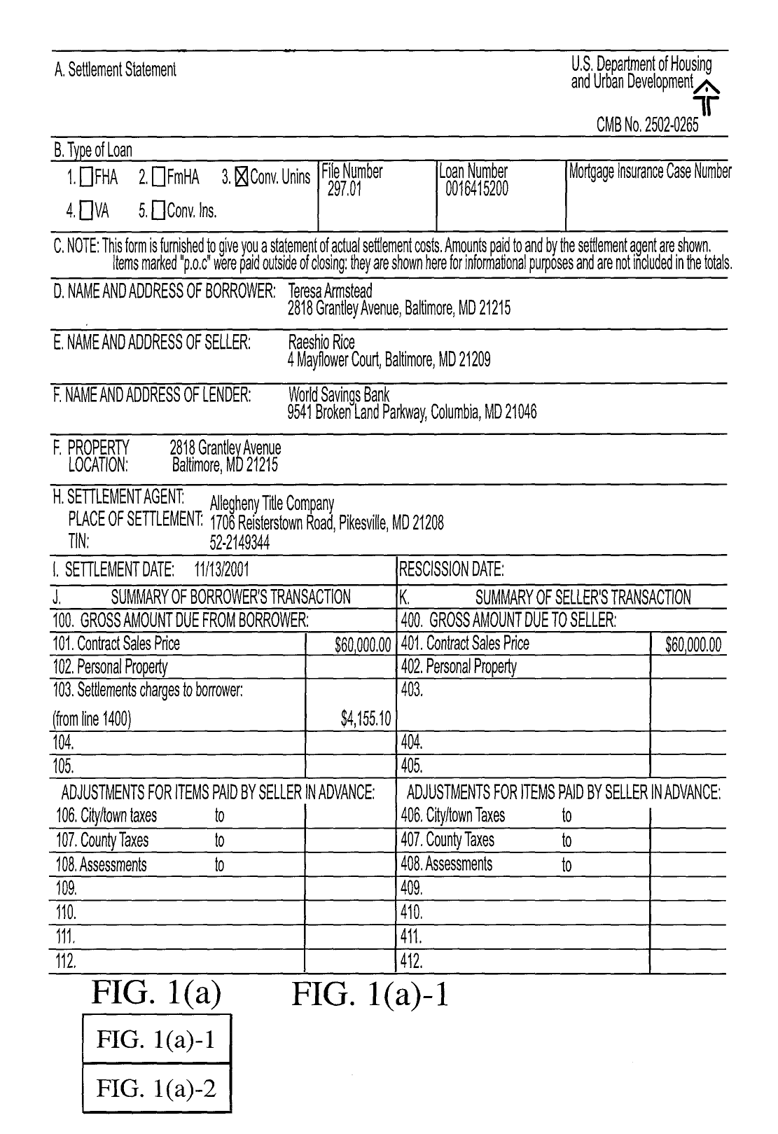

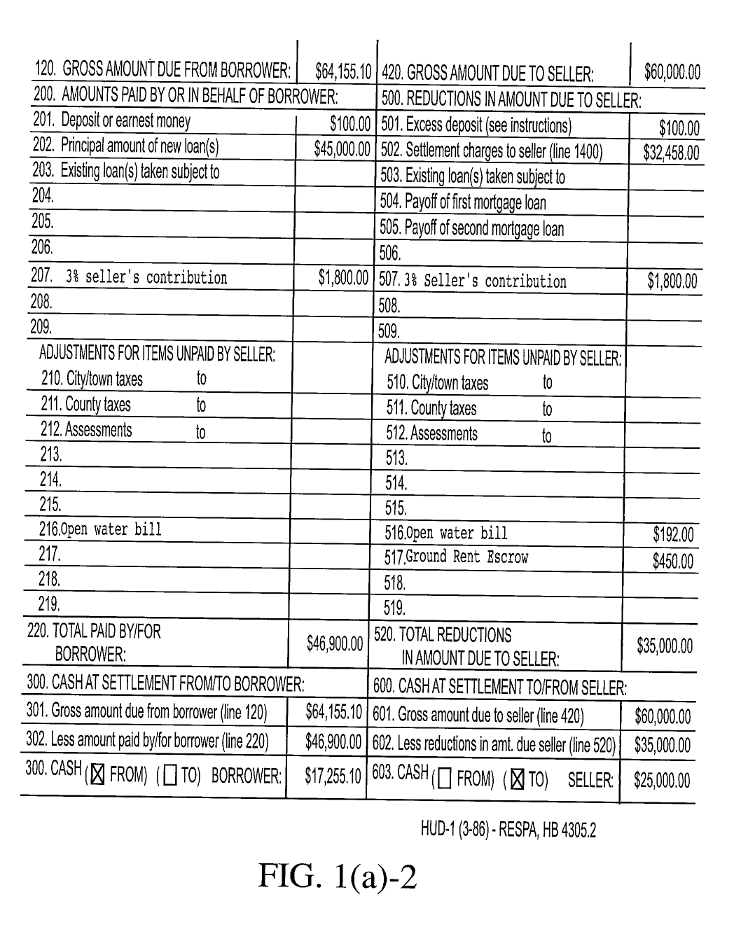

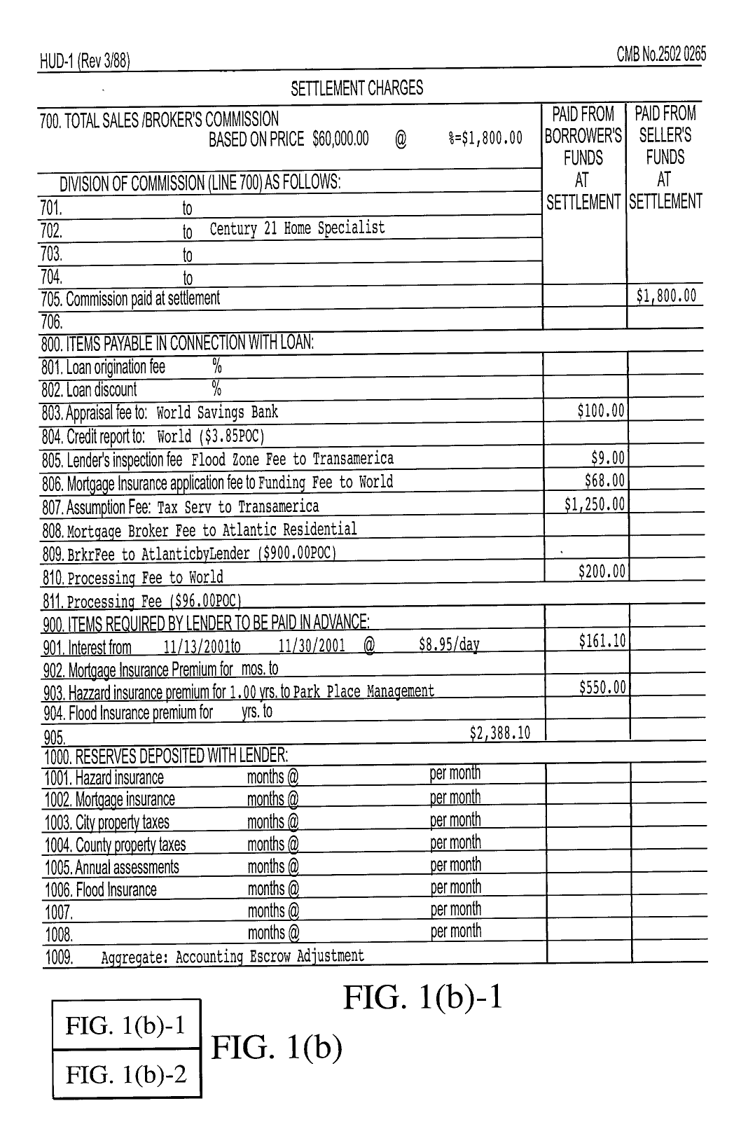

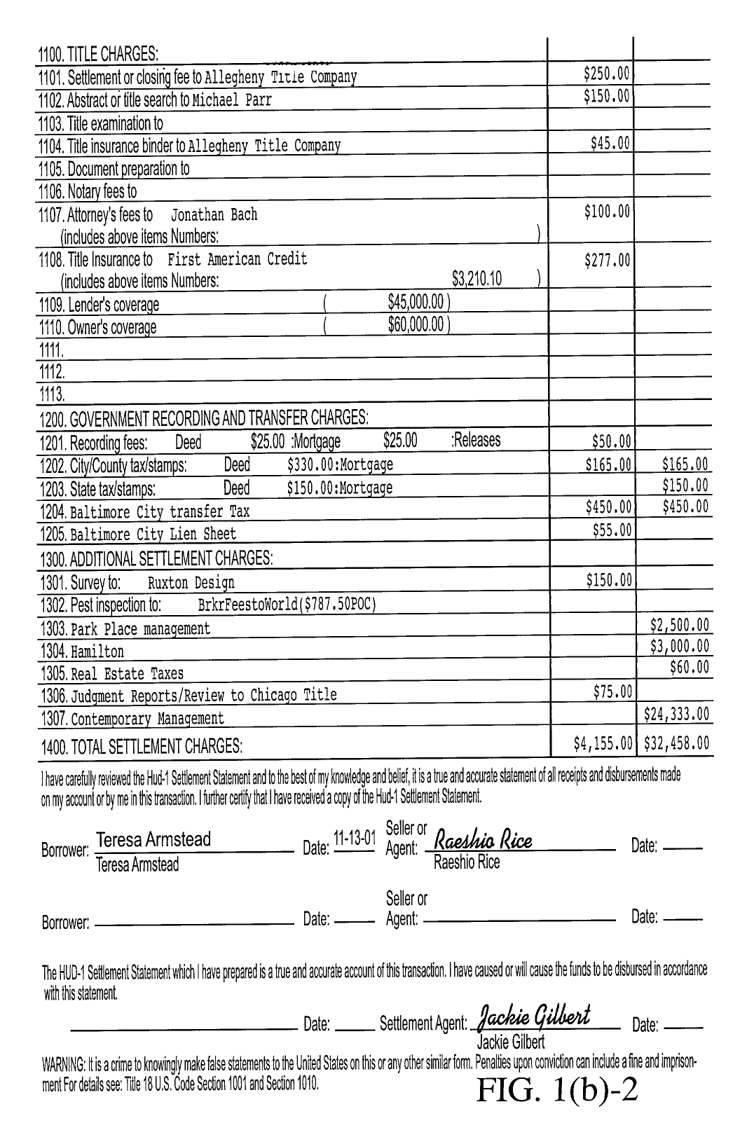

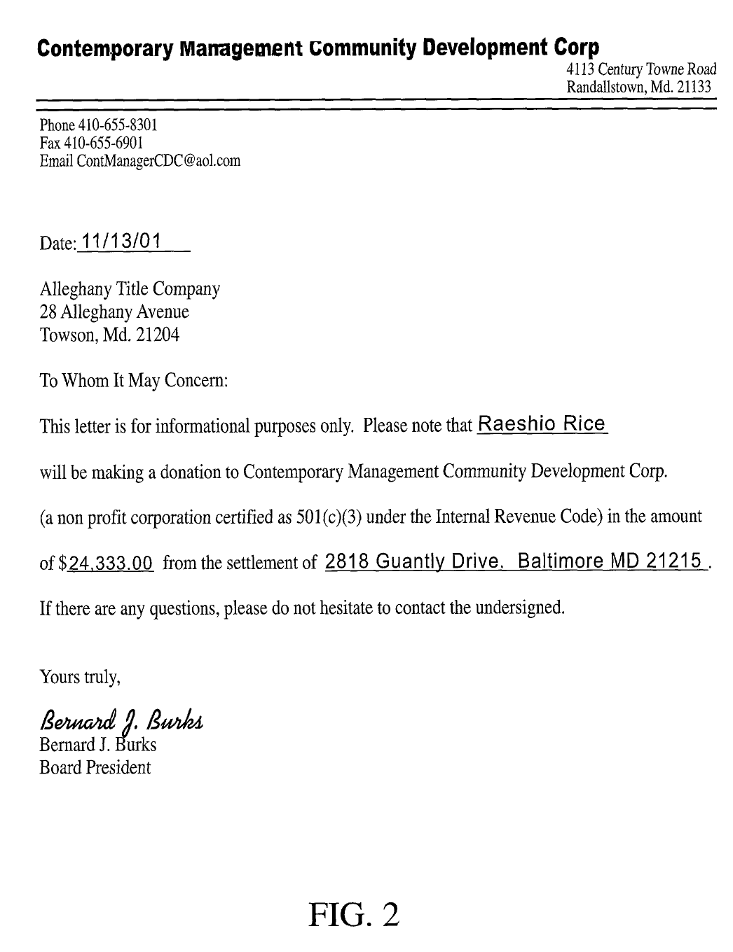

FIGS. 1(a) and 1(b) seek to more fully explain the method of the present invention by providing an example of how a Settlement Agreement that utilizes the present invention might appear. FIG. 1(a) gives a summary of the borrower's and seller's transactions. The seller's settlement charge of $32,458.00 is seen in FIG. 1(b) to include the amount of $24,333.00 which is a donation to Contemporary Management (CM), a nonprofit community development group. FIG. 2 provides an example of the type of document that CM might use with the seller to document this donation.

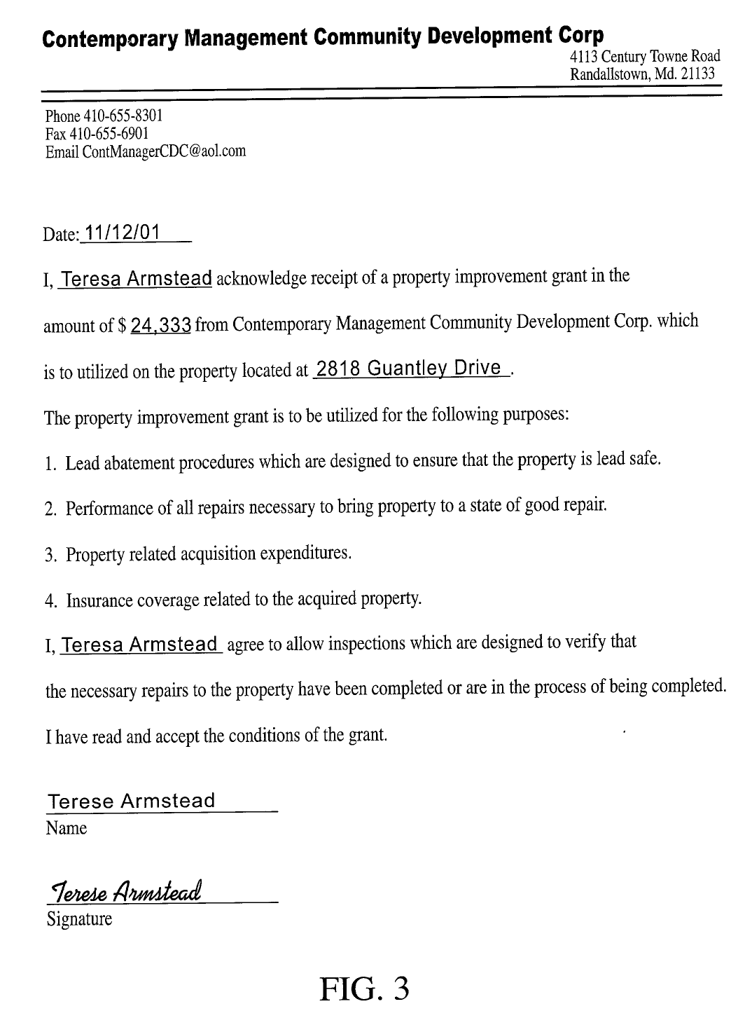

Although not shown in the Settlement Agreement, CM disperses $12,000 of this donation in the form of a grant to help the seller arrive at the cash amount that he will need to complete this transaction, $17,255.10. The balance of $12,333.00 is held by CM in an escrow account for the rehab contractor who has contracted to complete specified rehab work by a specified date that is acceptable to the buyer. FIG. 3 provides an example of the type of document that CM might have the buyer sign to document the buyer's receipt of the entirety of the seller's donation to CM and the purposes for which these funds may be used.

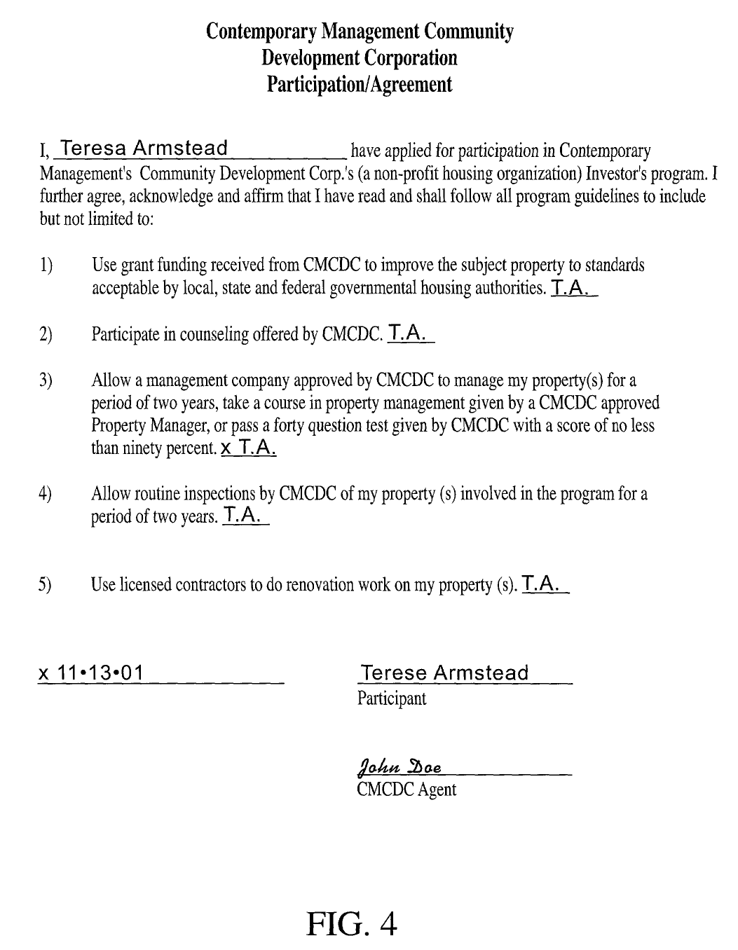

As previously noted, the buyer, especially if he or she is buying the property as a rental investment property, will typically have many other responsibilities than just paying the seller the agreed upon purchase price. FIG. 4 illustrates the type of agreement between the nonprofit community development group and investment buyer that might be used to document such additional agreements.

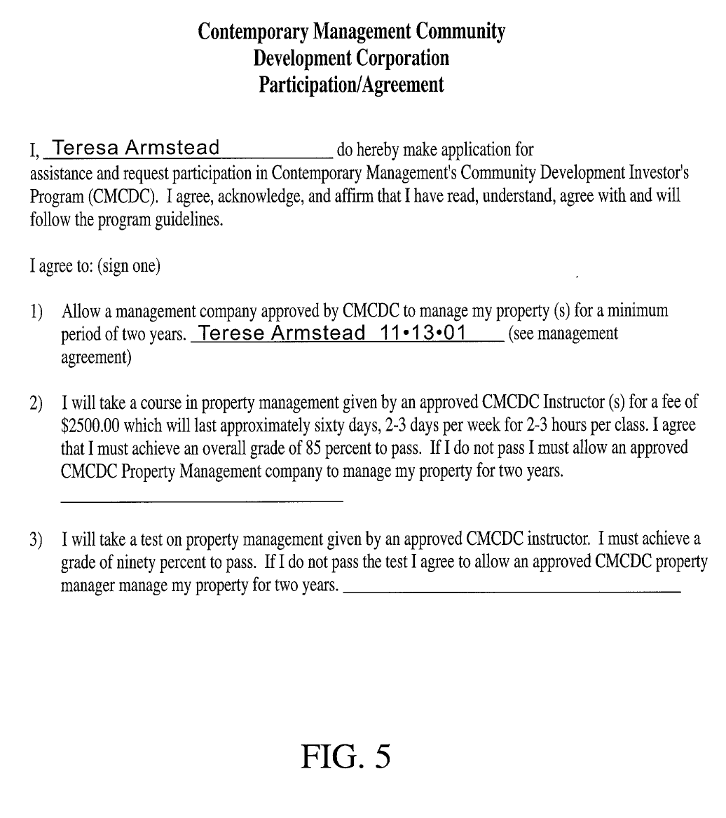

Since the buyer reflected in the FIG. 1 Settlement Agreement is a real estate investor who plans to rent the property, CM has elected to exercise its option of having the buyer use a real estate management company to manage the property for the first two years of the loan in order to try to ensure that the initial leasing of the property and its day-to-day management goes well so as to increase the chances that the buyer's monthly payments towards repayment of its mortgage on the property will be promptly paid. See FIG. 5.

To promote the success of such transactions, the nonprofit, community development group may offer educational services to prospective homeowners and investors regarding how to choose a property for purchase, budgeting to determine how much home the prospective buyer can afford, alternatives for financing the transaction, home inspection requirements, property repair and maintenance, including lead paint issues.

Additionally, the nonprofit, community development group will usually impose certain qualification requirements on prospective program participants. These may include: (i) screening and testing to assess the prospective buyer's competency to successfully participate in the program, (ii) satisfactory completion of a course offered by the nonprofit entity that teaches property management skills, (iii) agreement of buyer to use an approved property management group for a specified period, (iv) agreement of buyer to use approved, licensed contractors for required rehabilitation work, and (v) agreement of buyer to use property management, counseling services of the nonprofit entity for a specified period.

The preferred embodiments described herein are further intended to explain the best mode known of practicing the invention and to enable others skilled in the art to utilize the invention in various embodiments and with various modifications required by their particular applications or uses of the invention. It is intended that the appended claims be construed to include alternate embodiments to the extent permitted by the current art.

I claim:

1. A method for transferring real property involving a seller, a buyer, and a nonprofit entity, said method comprising the steps of
said seller contracting to sell said property to said buyer at a specified sales price and agreeing to donate a specified amount of said sales price to said nonprofit entity,
said nonprofit agreeing to accept said seller's donation and provide said seller with a receipt for said donation that can be used by said seller for tax purposes, and to use at least a specified amount of said donation to pay for specified repairs and renovations to said real property,
said buyer contracting to buy said real property from said seller under the condition that said specified repairs and renovations are made to said real property.

2. A method for transferring real property as recited in claim 1, wherein, if said buyer is an investor, said buyer also being provided by said nonprofit entity with services chosen from the group consisting of: (a) counseling directed at enabling said buyer to manage said property, (b) property management services for said property, and (c) periodic inspection of said property to help ensure its upkeep.

3. A method for transferring real property as recited in claim 1, wherein said property transfer occurring at a sales price approximately equivalent to its appraised value.

4. A method for transferring real property as recited in claim 1, wherein said donation occurring at a time chosen from the group consisting of at the closing of said property transfer or prior to the closing of said property transfer.

5. A method for transferring real property as recited in claim 1, wherein a contract for said repairs and renovations being completed at a time chosen from the group consisting of at the closing of said property transfer, prior to the closing of said property transfer or after the closing of said property transfer.

6. A method for transferring real property as recited in claim 1, wherein said property is a residential property and is located in an economically disadvantaged neighborhood and is in need of repair.

7. A method for transferring real property as recited in claim 1, wherein said nonprofit entity further agreeing to use a specified amount of seller's donation to provide said buyer with a grant which reduces the cost of said buyer purchasing said property.

8. A method for transferring real property as recited in claim 1, wherein said specified amount of seller's donation for said repairs and renovations being held in escrow by said nonprofit entity.

9. A method for transferring real property as recited in claim 2, wherein said property transfer occurring at a sales price approximately equivalent to its appraised value.

10. A method for transferring real property as recited in claim 2, wherein said donation occurring at a time chosen from the group consisting of at the closing of said property transfer or prior to the closing of said property transfer.

11. A method for transferring real property as recited in claim 2, wherein a contract for said repairs and renovations being completed at a time chosen from the group consisting of at the closing of said property transfer, prior to the closing of said property transfer or after the closing of said property transfer.

12. A method for transferring real property as recited in claim 2, wherein said nonprofit entity further agreeing to use a specified amount of seller's donation to provide said buyer with a grant which reduces the cost of said buyer purchasing said property.

13. A method for transferring real property as recited in claim 2, wherein said specified amount of seller's donation for said repairs and renovations being held in escrow by said nonprofit entity.

14. A method for transferring real property as recited in claim 9, wherein said donation occurring at a time chosen from the group consisting of at the closing of said property transfer or prior to the closing of said property transfer.

15. A method for transferring real property as recited in claim 14, wherein a contract for said repairs and renovations being completed at a time chosen from the group consisting of at the closing of said property transfer, prior to the closing of said property transfer or after the closing of said property transfer.

16. A method for transferring real property as recited in claim 15, wherein said property is a residential property and is located in an economically disadvantaged neighborhood and is in need of repair.

17. A method for transferring real property as recited in claim 16, wherein said nonprofit entity further agreeing to use a specified amount of seller's donation to provide said buyer with a grant which reduces the cost of said buyer purchasing said property.

18. A method for transferring real property as recited in claim 17, wherein said specified amount of seller's donation for said repairs and renovations being held in escrow by said nonprofit entity.
